(19) United States
(12) Patent Application Publication
(10) Pub. No.: US 2009/0199426 A1
(43) Pub. Date: Aug. 13, 2009

(54) Method for the Treatment of Wood or Wood Products

(75) Inventors: Ari Hottinen, Pajujarvi (FI); Pekka Hottinen, Alapitka (FI)

Correspondence Address: LADAS & PARRY LLP, 26 WEST 61ST STREET, NEW YORK, NY, 10023, US

(73) Assignee: TEKNOCOMP OY, Alapitka (FI)

(21) Appl. No.: 11/922,066

(22) PCT Filed: Jun. 14, 2006
(86) PCT No.: PCT/FI2006/000198

§ 371 Date: Dec. 12, 2007

(30) Foreign Application Priority Data
Jun. 17, 2005 (FI) 20050649

(51) Int. Cl. F26B 5/14

(52) U.S. Cl. 34/402

(57) ABSTRACT

A method for the treatment of wood or wood products, in which method moist wood or wood products (1) are first dried by pressing and further by heating so that a desired degree of dryness is reached. In the first stage, the wood or wood products (1) arranged between treating elements (2) are pressed between the treating elements (2) so that liquid is removed from the wood being treated. In the method, as a result of the combined effect of the pressure, the liquid and/or gaseous substance released into the chamber space from the wood material being treated and possibly also air circulation arranged in the treatment chamber, a change of temperature in the treatment chamber from a lower temperature (T1) to a higher temperature (T2) is achieved without supplying additional heat into the chamber.

### BACKGROUND OF THE INVENTION

The present invention relates to a method as defined in the preamble of claim 1 for the treatment of wood or wood products, in which method moist wood or wood products is/are dried by pressing between treating elements.

Methods for the treatment of wood or wood products, especially timber, are known in which wood is dried by pressing and simultaneously heating the wood. Typically, press-drying is performed using a press arranged in a drying chamber. A method of this type is disclosed in specification WO 94/26485. Other press-dying arrangements are also known, e.g. from specification FI 97961B. All these typically have the common feature that the pressing of timber and its drying by heat are performed in the same chamber. This requires a considerable heat endurance of the pressing apparatus used, especially because the temperatures may rise during the drying stage to a very high level, i.e. considerably over the boiling point of water. On the other hand, the amount of energy required in the drying stage is high as the aim is to dry large amounts of timber at a time. This correspondingly requires high-power pressing apparatus as the aim is to treat large amounts of timber at a time. There are also improved prior-art press-drying processes, e.g. as disclosed in specification WO 2005/049291, which have made it possible to avoid some of the above-described disadvantages. All the drying methods referred to above involve the use of considerable amounts of heat energy to enhance the drying process.

The object of the present invention is to create a completely new type of solution for press-drying of wood and wood products, designed to avoid the drawbacks of prior art. A further object of the invention is to achieve a solution in which an aim is to reduce the amount of additional thermal energy needed in the drying. Yet another objective of the invention is to achieve an efficient and flexible solution for the drying of timber, especially eucalyptus timber.

### BRIEF DESCRIPTION OF THE INVENTION

The invention is based on a concept according to which, as a result of the simultaneous effect of a liquid and/or gaseous substance released due to pressure from the wood material being treated, said substance preferably containing chemical compounds, and possible efficient air circulation, the temperature in the treatment chamber can be raised without any additional heat supply, and the heat thus generated is utilized in the drying process.

The method of the invention is mainly characterized in that, as a result of the combined effect of the pressure, the liquid and/or gaseous substance released into the chamber space from the wood material being treated and possibly also air circulation arranged in the treatment chamber, a change of temperature in the treatment chamber from a lower temperature to a higher temperature is produced without supplying additional heat into the chamber.

The method of the invention is additionally characterized by what is stated in claims 2-10.

The solution of the invention has numerous significant advantages. By applying the method of the invention, a very significant saving in heating energy is achieved. By utilizing the reaction of the substance released from eucalyptus wood as a result of pressure and the rise of temperature in the treatment chamber, the treatment can be carried out without additional heat energy. It has been established that the method of the invention is workable in particular in the case of eucalyptus wood, but it may work in the case of some other wood species as well. As compared to traditional drying of eucalyptus wood producing a yield of the order of only about 30 percent, which is due, among other things, to cracking and twisting of the timber, the method of the invention is capable of even a 90-percent yield without any significant heat energy costs.

Removing a proportion of the water from the wood material by pressure is more economical than drying it by merely heating. Vaporization of water requires more energy than pressing. When the temperature rises above the boiling point of water during the actual drying stage, a considerable proportion of the moisture has already been removed by pressure from the wood material to be treated, so that a considerably smaller amount of heat is needed for boiling the amount of water remaining in the wood material. Several drying and cooling chambers can be provided for one press. The amount of wood material to be treated at a time can thus be smaller to attain the same capacity than when only one drying chamber is used. The structures of the pressing apparatus used in the drying stage can be correspondingly designed to smaller dimensions. In addition, as the pressing chamber and the drying chamber can be separate from each other, it is possible to maintain mutually different conditions in them, thereby saving time and energy as compared to a solution where the pressing and drying are performed in the same space. The drying chamber can be made small as the requirements of the press need not be taken into account and additionally the fans used in the drying chamber can be positioned optimally. By using at least two fans arranged on opposite sides of the drying chamber and controlling the air stream in such a way that the air stream produced by a fan is passed to the suction side of another fan, a very efficient air circulation in the drying chamber is achieved. This further improves the efficiency of the drying stage. Recovery of heat from different stages of the method further reduces the energy requirement. By using lockable treating elements, a solution is further achieved in which the wood material being treated can be held under pressure even during the drying stage.

### BRIEF DESCRIPTION OF THE FIGURES

In the following, the invention will be described in detail with reference to an example and the attached drawing, wherein

FIG. 1 presents a simplified cross-section of an embodiment of the treatment chamber of the invention,

FIG. 2 presents a cross-sectional view of a part of an apparatus used in the method of the invention,

FIG. 3 presents an embodiment of the drying chamber used in the method according to the invention.

### DETAILED DESCRIPTION OF THE INVENTION

In the method of the invention, the wood or wood products, such as timber 1 is first brought to a stacking station (not shown in the figures). At the stacking station, the timber 1 is stacked (typically generally automatically) between treating elements 2. The timber thus stacked forms a batch.

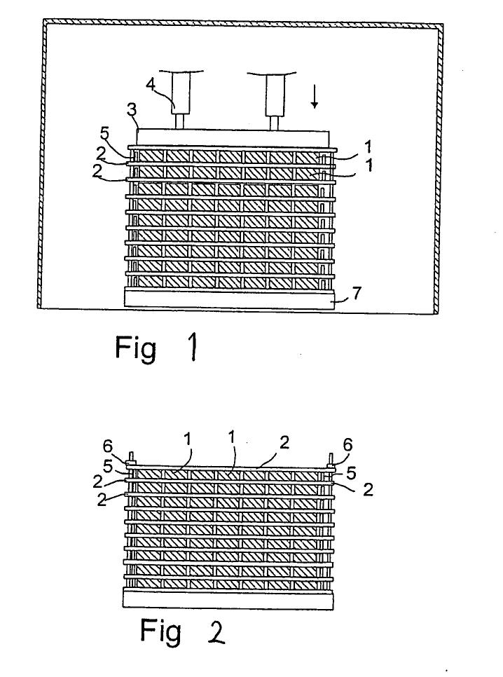

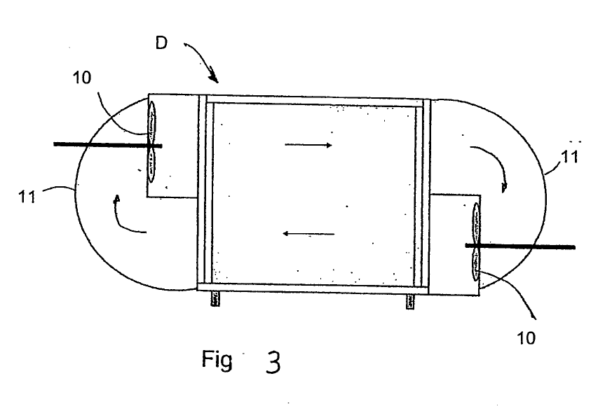

The batch is fed into the treatment chamber. FIG. 1 presents a simplified view of a treatment chamber used in the method of the invention. The combination consisting of the treating elements 2 placed one above the other and the timber 1 arranged in the spaces between them is in the chamber, where the combination is pressed by press elements 3, 4 so that the timber is compressed between the treating elements 2. The straining beam 3 of the press elements 3, 4 is typically moved by means of at least one cylinder-piston combination 4. In the case illustrated in the figure, a pressure is applied by the press elements 3, 4 to the upper surface of the topmost treating element 2, causing the timber being treated to be compressed between the treating elements. The bottommost one of the treating elements 2 may be arranged e.g. on a base 7 substantially immovable in the pressing direction.

In the treatment chamber, the combination of wood or wood products 1 and treating elements 2 is compressed until reaching the stoppers 5 defining the height of the pressing spaces, and thus the desired compression of the wood or wood products is achieved and free liquid is squeezed out of the wood in a quantity that may be as much as 50% of the liquid content. Typically, about 20-50% of the liquid content is removed by compressing. The compression pressure used depends on the kind of wood being treated and the thickness of the timber, being typically 5-20 kp/cm².

During the pressing stage, the wood may also be heated, in which case, depending on the properties of the wood species being treated, the wood material is softened and the water is removed more readily. During the pressing stage, the aim is to keep the treatment temperature below the boiling point of water. The temperature can be increased during the pressing stage, e.g. 40-80° C. As the wood is softened, the pressing becomes easier and a lower compression pressure can be used if desirable. By keeping the temperature below the boiling point of water, heating energy is saved.

It is to be noted that the wood material being treated is also heated as a consequence of the compression. Depending on the wood species or wood quality etc., there are variations in the rise of temperature of the wood material caused by the compression. In some wood species a considerable rise of temperature occurs as a result of the pressing, and therefore no additional heat may be needed at all or only very little additional heat may be needed during the pressing stage.

It has been unexpectedly ascertained that compressing certain wood species, e.g. eucalyptus wood, between the treating elements and simultaneously circulating air in the pressing chamber produce a considerable temperature-increasing effect in the treatment chamber without additional heat sources. The method of the invention is based on this phenomenon.

The method of the invention relates to treatment of wood or wood products, in which method moist wood or wood products 1 are first dried by pressing and further by heating until a desired degree of dryness is achieved. In the first stage, the wood or wood products 1 arranged between treating elements 2 are pressed between the treating elements 2 so that liquid is removed from the wood being treated. In the method, as a result of the combined effect of the pressure, the liquid and/or gaseous substance removed from the wood material being treated and possibly also air circulation arranged in the treatment chamber, a change of temperature in the treatment chamber from a lower temperature (T1) to a higher temperature (T2) is achieved without supplying additional heat into the chamber.

In the method, at least a proportion of the wood to be treated consists of eucalyptus wood or similar wood. As the substance, such as liquid and/or gas, released from the eucalyptus wood into the chamber space as a result of the pressure and typically containing eucalyptus oil expands on being released from the compressed wood and is possibly vaporized and may additionally react with other substances present in the chamber, such as oxygen, a temperature rise is produced.

The self-heating process according to the invention has been successfully used with the following elements:
1. A pressure is needed to cause the substance to be released from the wood.
2. Intensive air circulation is needed in the treatment chamber, typically over 5 m/s, preferably over 10 m/s.
3. Treating elements, i.e. cells, made of aluminum are used.

The substance is released from the wood and mixed with air in the pressurized conditions between the treating elements. When the mixture is released from between the treating elements into the chamber space outside the treating elements, the pressure falls and the temperature rises.

In press-drying, the amount of energy normally required for heating is in one case about 180-190 kW/m³. In the process of the invention, the heat energy required in the drying of eucalyptus wood is 0 kW/m³. Thus, a very large cost saving is achieved.

According to the method, the temperature in the treatment chamber rises about 1-5° C. per hour without any additional heat.

If necessary, the treatment chamber is heated by heating means to a first temperature T1. Typically, the starting temperature used may even be quite low, in which case, in an embodiment, the starting temperature T1 is of the order of 15-25° C.

In an embodiment of the method of the invention, the second temperature T2 is 50-200° C., preferably 80-170° C., most preferably 90-150° C. The second temperature may even by considerable higher than the values given above.

It has been established that the process will start even with a fairly small amount of wood to be treated. In one example where eucalyptus wood was treated, the amount of wood was 0.2 m³, whereas the typical amount of wood treated in a treatment chamber is 7 m³. Even with that relatively small amount of wood, initiation of the process and a sufficient temperature rise were achieved.

The treating elements used to press the wood comprise planar surfaces made of metal, typically light metal, e.g. aluminum. The treating elements are provided with openings and/or grooves to allow the moisture released from the wood to exit into the chamber space.

According to a preferred embodiment, the air circulation speed in the chamber is preferably over 5 m/s, most preferably over 10 m/s. the air is circulated by means of at least one fan.

The liquid released from the wood material contains oil, in particular eucalyptus oil or similar oil.

In the method, the pressure causes liquid and/or gaseous substances to be released from the wood. These are vaporized in the chamber and react with substances present in the chamber, such as oxygen, so that the temperature of the chamber rises.

In the pressing stage, the compression can be performed in a desired manner, uniformly with constant pressure or also e.g. by varying the compression pressure, causing the moisture to be equalized in the wood material being treated. The liquid flows out during the pressing stage through the openings (not shown) formed in the treating elements 2. The openings may be of different sizes or shapes, and their number may vary according to the embodiment. In an embodiment, the treating elements 2 may additionally be provided with ducts, e.g. for conveying a heating medium through them.

The combination of treating elements 2 and wood or wood products can be locked so that the wood or wood products placed in the pressing spaces remain under compression between the treating elements 2. In the locked position, the treating elements 2 typically have been moved against the thickness defining stoppers 5. FIG. 1 shows a diagrammatic representation of a combination of treating elements and timber as applied in a method according to the invention, in the locked position. The treating elements have been locked by means of locking devices 6 in place, allowing the combination of treating elements and timber to be moved into a treatment chamber, e.g. a drying chamber. The locking devices 6 are typically mechanical locking devices.

In the treatment chamber, the wood to be treated is heated over the boiling point of water so that the steam makes the chamber a substantially inert space, so the color of the wood being treated will not change. The wood is preferably heated to a temperature of over 120° C. to ensure that the wood will die, i.e. that a structural change will take place and the treated wood material will not undergo deformations or cracking. The adjustment of temperature during the drying process is implemented according to a program applicable for each wood material to be treated. The aim is to dry the wood material to be treated in the drying chamber to a moisture content of typically 8-10%. Efficient circulation of the medium has been arranged in the drying chamber. As illustrated in FIG. 3, the treatment chamber is provided with fans 10 disposed on opposite sides of the drying chamber. The flow produced by the fans has been fitted to be directed to the suction side of the fan placed on the opposite side of the drying chamber. Thus, the flow produced by the fan 10 feeds the opposite fan, which enhances the air circulation and the drying stage as a whole. According to the figure, the air flow is controlled by a guiding wall 11, which has the effect of creating a very efficient circulation of air flow in the drying chamber. The drying chamber may additionally comprise heat exchanger elements (not shown) known in themselves for supplying heat into the drying chamber. If necessary, it is possible to spray water into the drying chamber to produce water vapor. In this case, an inert space is formed in the drying chamber, at least in the vicinity of the wood material being treated.

Once the desired drying result has been achieved, the batch is moved from the drying chamber into a cooling chamber. In the cooling chamber, the wood material is cooled slowly according to a given program.

The arrangement may comprise a plurality of treatment chambers, such as drying chambers and cooling chambers, for one press. In this case, the wood or wood products 1 being treated are transferred in a selective manner from the first stage into one of a plurality of drying chambers.

From the cooling chamber, the batch is transferred into an unloading station (not shown). In the unloading station, the batch is unloaded and the timber is stacked and packed for delivery.

The method and apparatus of the invention can be used to dry timber and, if desirable, it can also be used for the production of compreg wood.

It is obvious to the person skilled in the art that the invention is not limited to the embodiments described above, but that it may be varied within the scope of the claims presented below. Features that may have been presented together with other features in the description can also be used separately from each other if necessary.

1. Method for the treatment of wood or wood products, in which method moist wood or wood products (1) are dried first by pressing and further by heating so that a desired degree of dryness is reached, the wood or wood products (1) arranged between treating elements (2) being pressed between the treating elements (2) so that liquid is removed from the wood being treated, characterized in that, in the method, as a result of the combined effect of the pressure, the liquid and/or gaseous substance released into the chamber space from the wood material being treated and possibly also air circulation arranged in the treatment chamber, a change of temperature in the treatment chamber from a lower temperature (T1) to a higher temperature (T2) is achieved without supplying additional heat into the chamber.

2. Method according to claim 1, characterized in that at least a proportion of the wood to be treated consists of eucalyptus wood or similar wood.

3. Method according to claim 1, characterized in that the temperature rises 1-5° C. per hour without additional heat.

4. Method according to claim 1, characterized in that, if necessary, the chamber is heated by heating means to a first temperature (T1).

5. Method according to claims 1, characterized in that, in the method, the second temperature (T2) is 50-200° C., preferably 80-170° C., most preferably 90-150° C.

6. Method according to claims 1, characterized in that the wood to be treated has been worked before the drying, e.g. by sawing.

7. Method according to 1, characterized in that the wood is pressed by means of treating elements (2) comprising pressing surfaces, and that the treating elements are at least partially made of metal, typically light metal, e.g. aluminum.

8. Method according to claim 1, characterized in that the air circulation speed in the chamber is preferably over 5 m/s, most preferably over 10 m/s.

9. Method according to claim 1, characterized in that the liquid released from the wood material contains oil, especially eucalyptus oil or similar oil.

10. Method according to claim 1, characterized in that in the method, as a result of the pressure, liquid and/or gaseous substances are released from the wood, and these are vaporized in the chamber and react e.g. with oxygen so that the temperature of the chamber rises.
